(19) United States
(12) Patent Application Publication
(10) Pub. No.: US 2009/0017394 A1
(43) Pub. Date: Jan. 15, 2009

(54) Hollow toner and process of preparing the same

(75) Inventors: Kyeong Pang, Suwon-si (KR); Chang-shin Park, Seongnam-si (KR); Kyung-yol Yon, Seongnam-si (KR); Min-young Cheong, Seoul (KR); Hong-chul Shin, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 12/068,196

(22) Filed: Feb. 4, 2008

(30) Foreign Application Priority Data
Jul. 10, 2007 (KR) 10-2007-0069217

(51) Int. Cl. G03G 9/00; G03G 5/00; G03G 15/01

(52) U.S. Cl. 430/109.31; 430/110.1; 430/109.3; 430/137.17; 430/125.3; 399/184

(57) ABSTRACT

Hollow toner and a process of preparing the same are provided. The hollow toner has a hollow sphere shape, wherein an outer layer surrounding the hollow sphere includes a polymer, a wax and a pigment. The hollow toner has excellent fixing properties under low energy and low pressure, and can be efficiently used at high-speed fixing. Also, a small amount of the hollow toner is consumed. Thus, the hollow toner can be efficiently applied to various apparatuses of forming an image such as a two-component low-temperature printer and super high-speed printer, and the hollow toner can be prepared by using a relatively simple process.

### CROSS-REFERENCE TO RELATED PATENT APPLICATION

This application claims the benefit under 35 U.S.C. §119(a) of Korean Patent Application No. 10-2007-0069217, filed on Jul. 10, 2007, in the Korean Intellectual Property Office, the disclosure of which is hereby incorporated by reference in its entirety.

### BACKGROUND OF THE INVENTION

1. Field of the Invention

The present invention relates to hollow toner and a process of preparing the toner. More particularly, the invention relates to a hollow toner having excellent fixing properties even under a low energy and low pressure since the center of particles of the toner are hollow. The toner can be efficiently applied to a high speed fixing, and consumed in a small amount.

2. Description of the Related Art

Conventionally, hollow particles are prepared by multiple stage emulsion polymerizations, single-stage emulsion polymerizations, phase separations between polymers and solvents, Shirasu phorous glass (SPG) membrane emulsion polymerizations, and the like. However, multiple stage emulsion polymerizations and single-stage emulsion polymerizations are not suitable for the preparation of toner particles since the latex has nano-sized particles. Thus, phase separations between polymers and solvents as suspension polymerizations and suspension or dispersion polymerizations using SPG membranes are suitable for the preparation of toner having a uniform particle size. However, an excess amount of a cross-linking agent is necessary in order to prepare hollow toner particles using conventional suspension polymerizations, and the hollow toner obtained by adding an excess amount of the cross-linking agent does not easily melt, and thus, fixing of a toner thus formed is not easily performed.

### SUMMARY OF THE INVENTION

The present invention provides hollow toner particles.

The present invention also provides a process of preparing the hollow toner particles.

The present invention also provides a method of forming an image using the hollow toner particles.

The present invention also provides an apparatus for forming an image using the hollow toner particles.

According to an aspect of the present invention, a toner comprising hollow toner particles is provided having a hollow sphere structure, wherein an outer layer surrounding the hollow sphere structure comprises a polymer, a wax and a pigment. The toner particles of the invention have a spherical shaped shell or outer layer formed from a polymer and have a hollow center cavity. In one embodiment, the cavity is filled with air surrounded by the polymer outer shell layer.

The outer layer may further comprise at least one component selected from the group consisting of a charge control agent, a chain transfer agent and a release agent.

A mean volume diameter of the particles of the hollow toner may be in the range of about 2 to 20 μm.

A mean volume diameter of the particles of the hollow toner may be in the range of about 3 to 10 μm.

The hollow toner may have a monodispersed particle size distribution.

A thickness of the outer layer may be in the range of about 0.1 to 5 μm.

The hollow sphere structure may be filled with air.

The polymer may be a polymer formed from a polymerizable monomer.

The polymer may be selected from the group consisting of a homopolymer, a random copolymer, a graft copolymer, and a block copolymer.

The polymerizable monomer may be at least one monomer selected from the group consisting of a vinyl monomer, a polar monomer having a carboxyl group, a monomer having an unsaturated polyester group, and a monomer having a fatty acid group.

The polymerizable monomer may be at least one monomer selected from the group consisting of a styrene-based monomer such as styrene, vinyl toluene, or α-methylstyrene; acrylate or methacrylate; a (meth)acrylate derivative such as methyl acrylate, ethyl acrylate, propyl acrylate, butyl acrylate, 2-ethyl hexyl acrylate, dimethylamino ethyl acrylate, methyl methacrylate, ethyl methacrylate, propyl methacrylate, butyl methacrylate, 2-ethyl hexyl methacrylate, dimethylaminoethyl methacrylate, acrylonitrile, methacrylonitrile, acrylamide, or methacryl amide; an ethylenically unsaturated monoolefin such as ethylene, propylene, or butylene; a halogenated vinyl such as vinyl chloride, vinylidene chloride, or vinyl fluoride; a vinylester such as vinyl acetate, or vinyl propionate; a vinyl ether such as vinyl methyl ether or vinyl ethyl ether; a vinyl ketone such as vinyl methyl ketone, or methyl isoprophenyl ketone; and a nitrogen-containing vinyl compound such as 2-vinylpyridine, 4-vinylpyridine, or N-vinyl pyrrolidone.

The pigment may be selected from the group consisting of yellow, magenta, cyan and black pigment.

The amount of the pigment may be in the range of about 0.1 to 20 parts by weight based on 100 parts by weight of the polymer.

The wax may be at least one wax selected from the group consisting of polyethylene-based was, polypropylene-based was, silicon wax, paraffin-based wax, ester-based wax, carnauba wax and metallocene wax.

The amount of the wax may be in the range of about 0.1 to 10 parts by weight based on 100 parts by weight of the polymer.

The surface of the hollow toner may further comprise an external additive.

According to another aspect of the present invention, a process of preparing a hollow toner is provided, the process comprising:

preparing a dispersion mixture by mixing a polymerizable monomer, a wax, a pigment, a polymerization initiator and a hydrophobic solvent;

preparing a dispersion medium by dissolving a dispersion stabilizer in a water-based solvent;

passing the dispersion mixture through pores of porous membrane under pressure into the dispersion medium and forming droplets of the dispersion mixture in the dispersion medium;

polymerizing the polymerizable monomer in the droplets of the dispersion mixture in the dispersion medium and forming particles having a polymer outer shell layer; and

drying the particles to form hollow toner particles.

The polymerization initiator may be selected from the group consisting of persulfate salts such as potassium persulfate, ammonium persulfate, and the like; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1, 1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile) etc.; and peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, and the like.

A pore size of the membrane may be in the range of about 2 to 10 μm.

A pore size of the membrane may be in the range of about 4 to 6 μm.

The hydrophobic solvent may be a hydrocarbon-based solvent.

The process may further comprise treating the hollow particles obtained in the drying operation using external additives.

According to another aspect of the present invention, a method of forming an image is provided comprising:

attaching a toner to the surface of a photoreceptor on which an electrostatic latent image is formed to form a visualized image; and

transferring the visualized image to a transfer medium, wherein the toner is a hollow toner having a hollow sphere shape, wherein an outer layer surrounding the hollow sphere comprises a polymer, a wax and a pigment.

According to another aspect of the present invention, an apparatus for forming an image is provided comprising:

an organic photoreceptor;

an image forming unit that forms an electrostatic latent image on the surface of the organic photoreceptor;

an unit for receiving a hollow toner having a hollow sphere shape, wherein an outer layer surrounding the hollow sphere comprises a polymer, a wax and a pigment;

a toner supply unit that supplies the hollow toner onto the surface of the organic photoreceptor in order to form a toner image by developing the electrostatic latent image; and

a toner transferring unit that transfers the toner image to a transfer medium from the surface of the organic photoreceptor.

These and other aspects of the invention will become apparent from the following detailed description of the invention which in conjunction with the drawings disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 shows a schematic process of forming hollow toner particles of the invention;

FIG. 2 shows a schematic cross-sectional view of the hollow toner;

FIG. 3 shows a schematic view of a SPG membrane used to prepare monodispersed droplets;

FIG. 4 shows a scanning electron microscope (SEM) image of monodispersed hollow toner particles prepared according to Example 1;

FIG. 5 shows a SEM image of a cross-sectional view of hollow toner particles prepared according to Example 1; and

FIG. 6 shows a SEM image of toner particles prepared according to Comparative Example 1.

FIG. 7 illustrates an image forming apparatus including hollow toner prepared according to an embodiment of the present invention;

### DETAILED DESCRIPTION OF THE INVENTION

Hereinafter, the present invention will now be described more fully with reference to the accompanying drawings, in which exemplary embodiments of the invention are shown.

The present invention provides a hollow toner having particles of a hollow sphere shape filled with air, wherein an outer layer surrounding the hollow sphere includes a polymer, a wax and a pigment. Such a hollow toner requires only low pressure and energy during a fixing process, and the amount of toner consumption can also be reduced because of the density of the hollow toner is reduced. The hollow toner particles have a hollow cavity defined by an outer layer or spherical shell formed from the polymer, was and pigment.

The hollow toner according to the present invention has particles of a hollow sphere shape as shown in FIG. 1. The outer layer surrounding the hollow sphere is formed of a polymer layer. FIG. 1 depicts the steps of forming the toner particles from a droplet of the solvent and monomer which polymerize to form an outer shell layer encapsulating the solvent.

In addition, the hollow toner may have monodispersed particle size distribution due to characteristics obtained during manufacturing processes. The monodispersed characteristics cause the hollow toner to have excellent properties since the particle size of the hollow toner is constant and uniform.

The particles of the hollow toner may have a mean volume diameter in the range of about 2 to 20 μm, preferably in the range of about 3 to 10 μm, and more preferably in the range of about 4 to 8 μm. When the mean volume diameter is greater than 20 μm, transferring or fixing process may not be properly performed. On the other hand, when the mean volume diameter is less than 2 μm, cleaning properties may be degraded.

The thickness of the outer layer of the particles of the hollow toner having particles of a hollow sphere shape according to the present invention is important to determine toner density or other characteristics. The thickness of a polymer layer as the outer layer may be in the range about of 0.1 to 5 μm, and preferably in the range of about 1 to 3 μm. When the thickness of the outer layer is greater than 3 μm, a fixing process may not be properly performed under low pressure and low energy. On the other hand, when the thickness of the outer layer is less than 0.1 μm, the toner particles may be easily broken.

The thickness of the outer layer may be in the range of about 2 to 40%, and preferably in the range of about 5 to 30% based on the diameter of the toner particles.

The polymer layer is formed by dropping a mixture including a water-insoluble polymerizable monomer, a hydrophobic solvent, or the like into a water-based solvent as a dispersion medium in the presence of a polymer dispersion stabilizer and polymerizing the polymerizable monomers. The polymer forming the polymer layer may be selected from the group consisting of a homopolymer, a random copolymer, a graft copolymer, and a block copolymer.

The polymer used to form the polymer layer is formed by polymerization of the polymerizable monomer. The polymerizable monomer may be at least one monomer selected from the group consisting of a vinyl monomer, a polar monomer having a carboxyl group, a monomer having an unsaturated polyester group, and a monomer having a fatty acid group. In particular, a mixture in which the vinyl monomer and the polar monomer having a carboxyl group are mixed in a predetermined ratio may be used as the polymerizable monomer.

For example, the polymerizable monomer may include at least one monomer selected from the group consisting of a styrene-based monomer such as styrene, vinyl toluene, or α-methylstyrene; acrylate or methacrylate; a (meth)acrylate derivative such as methyl acrylate, ethyl acrylate, propyl acrylate, butyl acrylate, 2-ethyl hexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, or methacryl amide; an ethylenically unsaturated monoolefin such as ethylene, propylene, or butylene; a halogenated vinyl such as vinyl chloride, vinylidene chloride, or vinyl fluoride; a vinylester such as vinyl acetate, or vinyl propionate; a vinyl ether such as vinyl methyl ether, or vinyl ethyl ether; a vinyl ketone such as vinyl methyl ketone, or methyl isoprophenyl ketone; and a nitrogen-containing vinyl compound such as 2-vinylpyridine, 4-vinylpyridine, or N-vinyl pyrrolidone.

A macromonomer as a comonomer which can inhibit agglomeration of the polymer by maintaining stability of the polymer may be added during the polymerization of the polymerizable monomer to form the outer layer.

The macromonomer used herein is an amphiphilic material having hydrophilic and hydrophobic groups and a polymer or an oligomer having at least one reactive functional group at its terminals. A mean weight average molecular weight of the macromonomer may be in the range of about 100 to 100,000, and preferably in the range of about 1,000 to 10,000. When the weight average molecular weight of the macromonomer is less than 100, physical properties of the toner may not be improved or the macromonomer cannot function efficiently as a stabilizer. On the other hand, when the weight average molecular weight of the macromonomer is greater than 100,000, the reaction conversion rate may be lowered.

The macromonomer may be one material selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexa functional polyester acrylate, dendritic polyester acrylate, carboxy polyester acrylate, fatty acid modified epoxy acrylate, and polyester methacrylate, but is not limited thereto.

The amount of the macromonomer may be in the range of about 0.1 to 10 parts by weight, preferably in the range of about 2 to 6 parts by weight, and more preferably in the range of about 2 to 4 parts by weight based on 100 parts by weight of the polymerizable monomer. When the amount of the macromonomer is less than 0.1 parts by weight, dispersion stability of toner particles may be reduced, and yield may be reduced. On the other hand, when the amount of the macromonomer is greater than 10 parts by weight, properties of the toner may be reduced.

The polymer layer which is the outer layer obtained by polymerizing the polymerizable monomers may include an internal additive such as a wax and a pigment, and may further include various internal additives such as a charge control agent, a chain transfer agent and a release agent. The internal additives may be added to the polymer layer by being mixed with the polymerizable monomer to form a dispersion mixture which is then polymerized.

The wax in the polymer layer may be appropriately selected according to the purpose of the toner to be formed. Examples of the wax that can be used include polyethylene-based wax, polypropylene-based wax, silicon wax, paraffin-based wax, ester-based wax, carnauba wax and metallocene wax, but are not limited thereto. The melting point of the wax may be in the range of about 50 to about 150° C. Wax constituents are physically attached to the toner particles, but are preferably not covalently bonded with toner particles.

The amount of the wax may be in the range of about 0.1 to 10 parts by weight based on 100 parts by weight of the polymer in the polymer layer. When the amount of the wax is less than 0.1 parts by weight, fixing properties and glossiness may be reduced. On the other hand, when the amount of the wax is greater than 10 parts by weight, problems regarding durability, environmental pollution, and hot offset may occur.

The polymer layer may include a pigment, and carbon black or aniline black may be used as the pigment for a black toner. A hollow toner according to the present invention is efficiently used to prepare a color toner. For color toner, carbon black or aniline black is used as a black colorant, and at least one of yellow, magenta, and cyan pigments are further included for colored colorants.

A condensation nitrogen compound, an isoindolinone compound, an anthraquinone compound, an azo metal complex, or an alyl imide compound can be used for the yellow pigment. Particularly, C.I. pigment yellow 12, 13, 14, 17, 62, 74, 83, 93, 94, 95, 109, 110, 111, 128, 129, 147, 168, 180 or the like can be used.

A condensation nitrogen compound, an anthraquinone compound, an quinacridone compound, a base dye lake compound, a naphthol compound, a benzo imidazole compound, a thioindigo compound, or a perylene compound can be used for the magenta pigment. Particularly, C.I. pigment red 2, 3, 5, 6, 7, 23, 48:2, 48:3, 48:4, 57:1, 81:1, 122, 144, 146, 166, 169, 177, 184, 185, 202, 206, 220, 221, 254 or the like can be used.

A copper phthlaocyanine compound or derivatives thereof, an anthraquinone compound, or a base dye lake compound can be used for the cyan pigment. Particularly, C.I. pigment blue 1, 7, 15, 15:1, 15:2, 15:3, 15:4, 60, 62, 66 or the like can be used.

Such pigments can be used alone or in a combination of two pigments or more, and are selected in consideration of color, chromacity, luminance, resistance to weather, dispersion properties in toner, and other desired properties.

The amount of the pigment may be in the range of about 0.1 to 20 parts by weight based on 100 parts by weight of the polymer in the polymer layer. The amount of the pigment should be sufficient to color the toner. When the amount of the pigment is less than 0.1 parts by weight based on 100 parts by weight of the polymer, the coloring effect is not sufficient. On the other hand, when the amount of the pigment is greater than 20 parts by weight, the manufacturing cost of the toner increases and sufficient frictional charge cannot be obtained.

The polymer layer may further include at least one of a release agent and a charge control agent. The polymerization initiator may be a hydrophobic polymerization initiator. The amount of each of the releasing agent, the charge control agent and the polymerization initiator may be in the range of about 0.1 to 3 parts by weight based on 100 parts by weight of the polymer.

During polymerizing of the polymerizable monomer, radicals are created by the polymerization initiator, and the radicals react with the polymerizable monomer to form the polymer.

Examples of the polymerization initiator are persulfate salts such as potassium persulfate, ammonium persulfate, etc.; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1, 1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile) etc.; and peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, and the like. Preferably, a hydrophobic polymerization initiator, such as azobis isobutyronitrile and benzoyl peroxide, may be used. In addition, an oxidation-reduction initiator which is a combination of the polymerization initiator and a reducing agent may be used.

A chain transfer agent is a material that converts a type of a chain carrier in a chain reaction. A new chain has much less activity than that of a previous chain. The polymerization degree of the monomer can be reduced and new chains can be initiated using the chain transfer agent. In addition, a molecular weight distribution of the polymer can be adjusted using the chain transfer agent.

Examples of the chain transfer agent are, but are not restricted to: sulfur-containing compounds such as dodecanethiol, thioglycolic acid, thioacetic acid and mercaptoethanol; phosphorous acid compounds such as phosphorous acid and sodium phosphorate; hypophosphorous acid compounds such as hypophosphorous acid and sodium hypophosphorate; and alcohols such as methyl alcohol, ethyl alcohol, isopropyl alcohol and n-butyl alcohol.

The release agent can be used to protect a photoreceptor and prevent deterioration of developing, thereby obtaining a high quality image. A release agent may be a high purity solid fatty acid ester material. Examples of the release agent are low molecular weight polyolefins such as low molecular weight polyethylene, low molecular weight polypropylene, low molecular weight polybutylenes, and the like; paraffin wax; and multi-functional ester compound. The release agent used in the present invention may be a multifunctional ester compound composed of alcohol having three functional groups or more and carboxylic acid.

The polyhydric alcohol with at least three functional groups may be an aliphatic alcohol such as glycerin, pentaerythritol and pentaglycerol; an alicyclic alcohol such as chloroglycitol, quersitol and inositol; an aromatic alcohol such as tris(hydroxymethyl)benzene; a sugar such as D-erythrose, L-arabinose, D-mannose, D-galactose, D-fructose, L-lamunose, sucrose, maltose and lactose; or a sugar-alcohol such as erythrite, D-trate, L-arabite, admit and chissirite.

The carboxylic acid may be an aliphatic carboxylic acid such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid and tetrolic acid; an alicyclic carboxylic acid such as cyclohexanecarboxylic acid, hexahydroisophthalic acid, hexahydroterephthalic acid, and 3,4,5,6-tetrahydrophthalic acid; or an aromatic carboxylic acid such as benzoic acid, cumic acid, phthalic acid, isophthalic acid, terephthalic acid, trimethinic acid, trimellitic acid, hemimellitic acid.

The charge control agent may be preferably selected from the group consisting of a salicylic acid compound containing metals such as zinc or aluminum, boron complexes of bis diphenyl glycolic acid, and silicate. More preferably, dialkyl salicylic acid zinc, boro bis (1,1-diphenyl-1-oxo-acetyl potassium salt), and the like can be used.

The internal additives described above may be included in the polymer layer, and various external additives may be applied to the hollow toner. The external additive may be silica, and the like.

The hollow toner of the present invention may be prepared using a membrane dispersion method described below.

First, a dispersion mixture can be prepared by mixing a polymerizable monomer, a wax, a pigment, a polymerization initiator and a hydrophobic solvent, and a dispersion medium is separately prepared by dissolving a dispersion stabilizer in water. Droplets of the dispersion mixture are formed in the dispersion medium by dropping the dispersion mixture into the dispersion medium while the dispersion mixture is passed through pores of a membrane under pressure. The droplets of the dispersion mixture are polymerized to prepare hollow particles. The particles formed in the dispersion medium have an outer polymer shell layer that encapsulates the hydrophobic solvent of the dispersion mixture. Then, the hollow particles are separated from the dispersion medium and dried to prepare hollow toner. The dying step removes the hydrophobic solvent within the outer polymer shell layer to form hollow toner particles having a hollow cavity containing air. After drying, various external additives may be applied thereto.

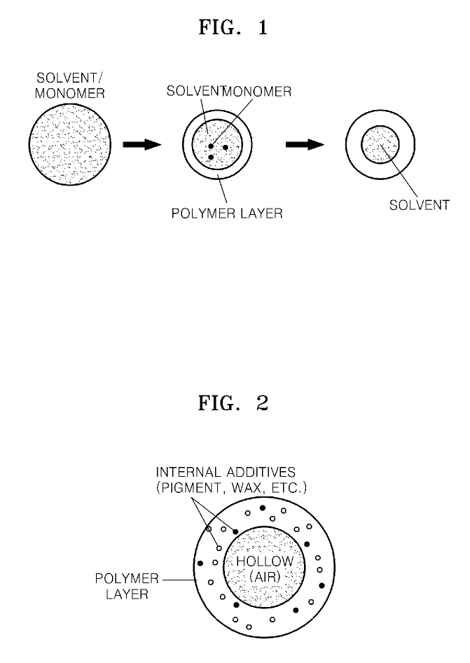

In the membrane dispersion technology used to prepare the hollow toner as shown in FIG. 2, the dispersion mixture including the polymerizable monomer, the wax, the hydrophobic solvent, and other components is passed through pores of the membrane under pressure, and then monodispersed droplets of the mixture are added to the dispersion medium. When the toner has a monodispersed particle size distribution, it is advantageous that further processes such as sorting are not necessary.

Since the dispersion mixture is water-insoluble or hydrophobic, droplets of the dispersion mixture are formed in a water-based dispersion medium. Subsequently, suspension polymerization or dispersion polymerization of the droplets is performed.

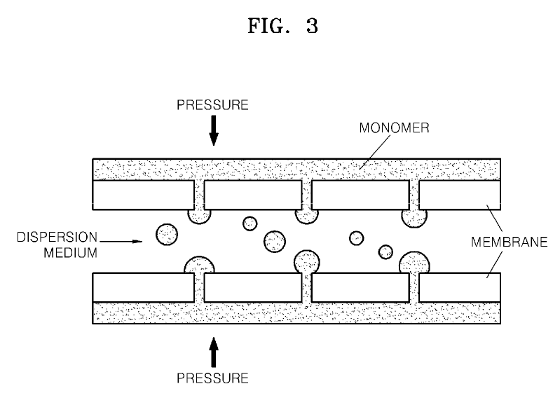

FIG. 3 shows a schematic view of forming the droplets. Droplets of the dispersion mixture are ejected from the membrane in the dispersion medium, where the dispersion mixture includes a wax, a pigment, a hydrophobic solvent, a polymerizable monomer, and other components. As the polymerization proceeds, a polymer formed by polymerization of the polymerizable monomer forms an outer layer due to repulsive power of the hydrophobic solvent in the water-based solvent of the dispersion medium, and the hydrophobic solvent and unreacted monomers remain inside the droplets and the outer polymer layer. When the polymerization is finally completed, the outer layer is formed of a polymer layer including the wax, the pigment, and the like, and the inside is filled with the hydrophobic solvent. The hydrophobic solvent is removed during the drying process, and thus the inside of the toner particle is formed by the outer polymer shell is filled with air.

Any membrane that can eject droplets having monodispersed particle size distribution can be used as the membrane for the preparation of the hollow toner without limitation. Examples of the membrane include SPG membranes, single pore membranes and micro-engineered membranes. Since the pore size of the membrane is a factor which determines the size of droplets and the size of the resulting particles of the hollow toner, an appropriate pore size needs to be selected to form the desired hollow toner. Herein, a membrane having a pore size in the range of about 2 to 10 μm, and preferably in the range of about 3 to 8 μm can be used.

Regarding the toner composition which is used to form the hollow toner, the polymerizable monomer, the wax and the pigment are described above, and the hydrophobic solvent may be a hydrocarbon-based solvent, for example porogen, and more particularly, hexadecane, methylene chloride, toluene, xylene, or the like in consideration of repulsive power in a waterborne dispersion medium.

The size of the hollow toner can be determined according to the amount of the hydrophobic solvent or the degree of hydrophobicity, and thus the amount of the hydrophobic solvent may be in the range of about 10 to 100 parts by weight based on 100 parts by weight of the polymerizable monomer. When the amount of the hydrophobic solvent is less than 10 parts by weight, the outer layer may become too thick. On the other hand, when the amount of the hydrophobic solvent is greater than 100 parts by weight, the obtained toner particles may be broken.

The toner composition including the hydrophobic solvent is mixed and pulverized to obtain a uniform particle size. The pulverization may be performed using milling or the like.

Hollow toner having appropriate properties can be prepared by a membrane dispersion technology without using a cross-linking agent. However, a small amount of a cross-linking agent can be used to enhance durability of particles. The cross-linking agent may be an acryl, (meth)acrylate or di(meth)acrylate cross-linking agent having a vinyl-based double bond at one end or both ends which is polymerizable through radical initiation. The acryl cross-linking agent may be divinyl benzene, and examples of the acrylate cross-linking agent are 1,2-ethanedioldiacrylate; 1,3-propanedioldiacrylate; 1,3-butanedioldiacrylate; 1-4-butanedioldiacrylate; 1,5-pentanedioldiacrylate; 1,6-hexanedioldiacrylate; ethyleneglycoldiacrylate; propyleneglycoldiacrylate; butyleneglycoldiacrylate; triethyleneglycoldiacrylate; polyethyleneglycoldiacrylate; polypropyleneglycoldiacrylate; polybutyleneglycoldiacrylate; alkylacrylate; 1,2-ethanedioldimethacrylate; 1,3-propanediolmethacrylate; 1,3-butanedioldimethacrylate; ethyleneglycoldimethacrylate; propyleneglycoldimethacrylate; butyleneglycoldimethacrylate; triethyleneglycoldimethacrylate; polyethyleneglycoldimethacrylate; polypropyleneglycoldimethacrylate; polybutyleneglycoldimethacrylate; allylmethacrylate; urethane acrylate; and diallylmalate, and the acrylate cross-linking agents can be used alone or in a combination of two or more compounds.

The amount of the cross-linking agent may be in the range of about 0.01 to 1 parts by weight based on 100 parts by weight of the polymerizable monomer. When the amount of the cross-linking agent is greater than 1 part by weight, fixing of the toner may not be properly performed.

Radicals are created by a polymerization initiator, and a hydrophobic compound may be used as the polymerization initiator. Examples of the polymerization initiator are persulfate salts such as potassium persulfate, ammonium persulfate, and like; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1, 1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile) etc.; and peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, and other.

The toner composition may further include a release agent, a charge control agent and a chain transfer agent which are described above.

A predetermined pressure needs to be applied in order to eject the dispersion mixture including the toner composition through pores of the membrane. The pressure may be determined to be sufficient in order to eject droplets having a desired size at a constant rate. The pressure may vary according to the concentration of the dispersion mixture, the size of the pores of the membrane or the size of the membrane.

The dispersion medium to which the dispersion mixture is ejected may be a water-based dispersion medium, and preferably a water-based dispersion medium including an appropriate amount of dispersion stabilizer dissolved in water. That is, the water-based dispersion medium can be prepared by dissolving at least one stabilizer selected from the group consisting of a nonionic, cationic or anionic surfactant, a citrate (such as sodium citrate or citric acid), polyvinyl pyrrolidone (PVP), and polyvinyl alcohol (PVA) in water, for example distilled water. Here, the dispersion stabilizer controls particle size and distribution using its inherent adsorbing properties when the polymer layer is formed from the polymerizable monomer. That is, the stabilizer molecules are adsorbed to the surface of the toner in the solution in which toner particles are formed because of inherent properties of the stabilizer which is adsorbed to the interface to inhibit agglomeration among the toner particles. Thus, hollow toner particles having monodispersed particle size distribution can be prepared. The stabilizer is removed after the polymerization by being reacted with a basic compound such as sodium hydroxide.

The amount of the stabilizer may be in the range of about 0.3 to 5 parts by weight based on 100 parts by weight of the water-based solvent. When the amount of the stabilizer is less than 0.3 parts by weight, stability of particles may not be sufficient. On the other hand, when the amount of the stabilizer is greater than 5 parts by weight, advantages of excess amount of the stabilizer may be negligible, and thus the hollow toner may become less economical.

The toner composition is dropped into the dispersion medium described above through the pores of the membrane, and then the droplets are polymerized to form hollow particles. The polymerization may be performed at a temperature in the range of about 50 to 90° C. for 4 to 12 hours. Particularly, the polymerization may be performed while heating, stirring and purging inside of the reactor by nitrogen gas, or the like.

Since the hydrophobic solvent is filled in the hollow toner prepared according to the polymerization process, the hydrophobic solvent is removed by drying the toner particles, and thus the hollow toner particles are filled with air.

The surface of the dried hollow toner is treated with various external additives such as silica, and charges are controlled to prepare the final hollow toner.

The final hollow toner is efficiently applied to various methods of or apparatuses for forming an image. In particular, since the hollow toner is simply manufactured and has monodispersed particle size distribution, additional sorting processes are not necessary. Toner can also be fixed under low pressure and low energy and the toner consumption can be reduced because of reduced density.

According to another embodiment of the present invention, a method of forming an image is provided including: attaching a toner to the surface of a photoreceptor on which an electrostatic latent image is formed to form a visualized image; and transferring the visualized image to a transfer medium, wherein the toner is a hollow toner according to the present invention.

A representative electrophotographic image forming process includes charging, exposure to light, developing, transferring, fixing, cleaning, and antistatic process operations, and a series of processes of forming images on a receptor.

In the charging process, a surface of a photoreceptor is charged with negative or positive charges, whichever is desired, by a corona or a charge roller. In the light exposing process, an optical system, conventionally a laser scanner or an array of diodes, selectively discharges the charged surface of the photoreceptor in an imagewise manner corresponding to a final visual image formed on a final image receptor to form a latent image. Electromagnetic radiation that can be referred to as “light” includes infrared radiation, visible light, and ultraviolet radiation.

In the developing process, appropriate polar toner particles generally contact the latent image of the photoreceptor, and conventionally, an electrically-biased developer having an identical potential polarity to the toner polarity is used. The toner particles move to the photoreceptor and are selectively attached to the latent image by electrostatic electricity, and form a toner image on the photoreceptor.

In the transferring process, the toner image is transferred to the final image receptor from the photoreceptor, and sometimes, an intermediate transferring element is used when transferring the toner image from the photoreceptor to aid the transfer of the toner image to the final image receptor.

In the fixing process, the toner image of the final image receptor is heated and the toner particles thereof are softened or melted, thereby fixing the toner image to the final image receptor. Another way of fixing is to fix toner on the final image receptor under high pressure with or without the application of heat.

In the cleaning process, remaining toner on the photoreceptor is removed.

Finally, in the antistatic process, charges of the photoreceptor are exposed to light of a predetermined wavelength band and are reduced to a substantially uniform, low value, and thus the residue of the original latent image is removed and the photoreceptor is prepared for a next image forming cycle.

According to another embodiment of the present invention, an apparatus for forming an image is provided comprising: an organic photoreceptor; a charging unit for charging the surface of the organic photoreceptor; an image forming unit that forms an electrostatic latent image on a surface of the organic photoreceptor; a unit for receiving the toner; a unit that supplies the toner onto the surface of the organic photoreceptor in order to form a toner image by developing the electrostatic latent image; and a toner transferring unit that transfers the toner image to a transfer medium from the surface of the organic photoreceptor, wherein the toner is the hollow toner according to the present invention.

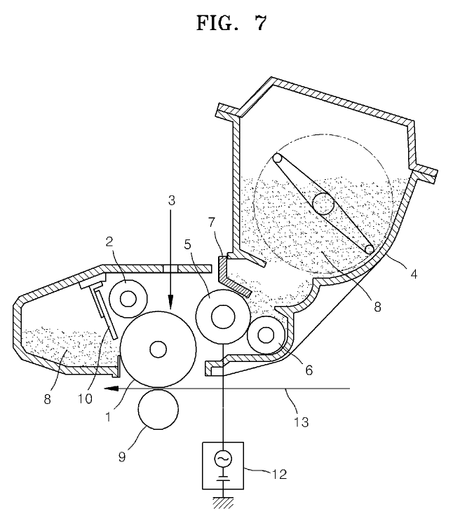

FIG. 7 is a schematic diagram of a non-contact developing type image forming apparatus using the hollow toner prepared using the method according to an embodiment of the present invention. The operating principles of the image forming apparatus are explained below.

A developer 8, which is a nonmagnetic one-component developer of a developing unit 4, is supplied to a developing roller 5 through a feeding roller 6 formed of an elastic material such as a polyurethane foam or sponge. The developing roller 5 is charged by a charging unit 12. The developer 8 supplied to the developing roller 5 reaches a contact point between the developing roller 5 and a developer regulation blade 7 as the developing roller 5 rotates. The developer regulation blade 7 is formed of an elastic material such as metal, rubber, or the like. When the developer 8 passes the contact point between the developing roller 5 and the developer regulation blade 7, the developer 8 is smoothed into a thin layer that is sufficiently charged. The developing roller 5 transfers the thin layer of the developer 8 to a developing domain where the thin layer of the developer 8 is developed on the electrostatic latent image of a photoreceptor 1, which is a latent image carrier. The electrostatic latent image is formed by scanning light 3 onto the photoreceptor 1.

The developing roller 5 and the photoreceptor 1 face each other with a constant distance therebetween. The developing roller 5 rotates counterclockwise and the photoreceptor 1 rotates clockwise.

The developer 8 transferred to the developing domain of the photoreceptor 1 forms an electrostatic latent image on the photoreceptor 1 according to the intensity of an electric charge generated due to a difference between an AC voltage superposed with a DC voltage applied to the developing roller 5 and a latent image potential of the photoreceptor 1 that is charged by a charging unit 2. Accordingly, a toner image is formed.

The developer 8 developed on the photoreceptor 1 is transferred to a transferring device 9 as the photoreceptor 1 rotates. The developer 8 developed on the photoreceptor 1 is transferred to a sheet of paper 13 by corona discharge or a roller to which a high voltage having inverse polarity of the developer 8 is applied as the paper 13 passes through the developer 8 developed on the photoreceptor 1, and thus an image is formed.

The image transferred to the printing paper 13 passes through a fusing device (not shown) that provides high temperature and high pressure, and the image is fused to the printing paper 13 as the developer 8 is fused to the printing paper 13. Meanwhile, any developer 8′ remaining on the developing roller 5 and which is not developed is transferred back to the feeding roller 6 contacting the developing roller 5. Remaining developer 8′ that is undeveloped on the photoreceptor 1 is collected by a cleaning blade 10. The above processes are repeated.

The present invention will be described in more detail with reference to the examples below. The following examples are for illustrative purposes only and are not intended to limit the scope of the invention.

### EXAMPLE 1

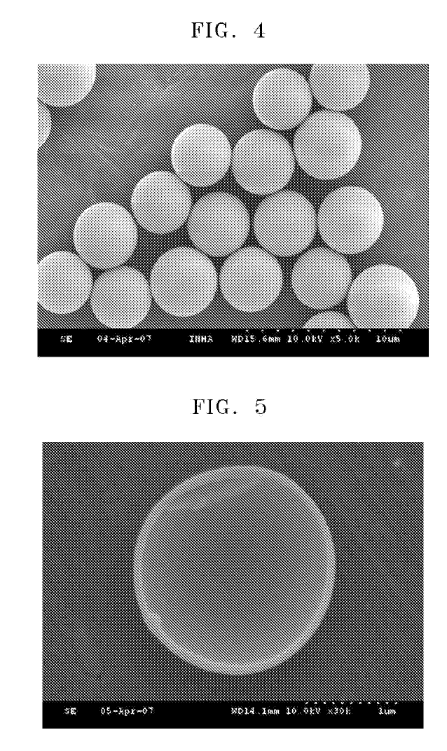

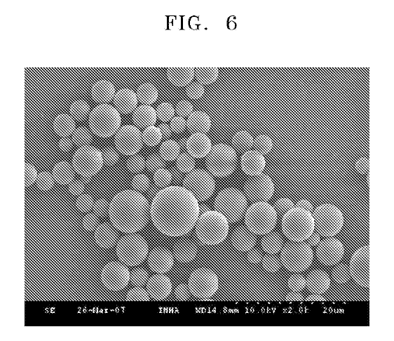

80 g of styrene, 30 g of n-butyl acrylate, 5 g of methacrylate, 2.3 g of hexadecane, 0.2 g of divinyl benzene, 5 wt % a black pigment (Mogul L), 0.5 wt % of a charge control agent (E-108), and 5 wt % of a wax (WE5) were mixed at room temperature for 12 hours using a ball mill to prepare a mixture, wherein the wt % is based on the total weight of the polymerizable monomer, and 2 wt % of AIBN was added to the mixture to prepare 126 g of a dispersion mixture. The dispersion mixture was passed through pores having the size of 4 μm of a SPG membrane which was connected to a reactor under pressure, and dropped into 500 mL of a dispersion medium in which PVP was dissolved in water to a concentration of 0.5%. The reactor was equipped with a stirrer, a cooler, and a nitrogen nozzle. After the dispersion mixture was dropped, the temperature of the reactor was raised to 80° C., and polymerization was performed for 8 hours. When the polymerization was terminated, the PVP which is a dispersion stabilizer was removed by a reaction with sodium hydroxide, and the resultant was filtered and washed using distilled water and dried. The dried particles are externally treated with silica to prepare hollow toner having a mean volume diameter of 5 μm. A scanning electron microscope (SEM) image of the obtained hollow toner is shown in FIG. 4, and the obtained hollow toner has uniform particle size distribution and is monodispersed according to FIG. 4. A SEM image of a cross-sectional view of the hollow toner is shown in FIG. 5, and it can be seen from FIG. 5 that the outer layer is uniformly formed.

### EXAMPLE 2

Hollow toner was prepared in the same manner as in Example 1, except that PY-74 was used as a yellow pigment instead of the black pigment.

### EXAMPLE 3

Hollow toner was prepared in the same manner as in Example 1, except that PB 15:4 was used as a cyan pigment instead of the black pigment.

### EXAMPLE 4

Hollow toner was prepared in the same manner as in Example 1, except that PR122 was used as a magenta pigment instead of the black pigment.

### COMPARATIVE EXAMPLE 1

80 g of styrene, 30 g of n-butyl acrylate, 5 g of methacrylate, 0.2 g dimethyl benzene, 5 wt % of a black pigment (Mogul-L), 0.5 wt % of a charge control agent (E-108), and 5 wt % of a wax (WE5) 5 were mixed at room temperature for 12 hours using a ball mill to prepare a mixture, and 2 wt % of AIBN was added to the mixture to prepare 126 g of a dispersion mixture. The dispersion mixture was dropped into a dispersion medium in which PVP was dissolved in water to a concentration of 0.5%. The reactor was equipped with a stirrer, a cooler, and a nitrogen nozzle. After the dispersion mixture was dropped, the temperature of the reactor was raised to 80° C., and polymerization was performed for 8 hours. When the polymerization is terminated, the PVP which was a dispersion stabilizer was removed by a reaction with sodium hydroxide, and the resultant was filtered and washed using distilled water and dried. The dried particles were externally treated with silica to prepare hollow toner having a mean volume diameter of 5 μm. A SEM image of the obtained hollow toner is shown in FIG. 6, and it can be seen from FIG. 6 that the hollow toner does not have uniform particle size distribution and is not monodispersed.

The present invention provides hollow toner having particles which are filled with air. The hollow toner has excellent fixing properties under low energy and low pressure, and can be efficiently used in high-speed fixing. Also, a small amount of the hollow toner is consumed. Thus, the hollow toner can be efficiently applied to various apparatuses of forming an image such as a two-component low-temperature printer and super high-speed printer, and the hollow toner can be prepared by using a relatively simple process.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A toner comprising hollow toner particles having a hollow sphere structure, wherein an outer layer forms the hollow sphere structure and comprises a polymer, a wax and a pigment.

2. The hollow toner of claim 1, wherein the outer layer further comprises at least one component selected from the group consisting of a charge control agent, a chain transfer agent and a release agent.

3. The hollow toner of claim 1, wherein the particles have a mean volume diameter in the range of about 2 to 20 μm.

4. The hollow toner of claim 1, wherein the particles have a mean volume diameter in the range of about 3 to 10 μm.

5. The hollow toner of claim 1, having a monodispersed particle size distribution.

6. The hollow toner of claim 1, wherein a thickness of the outer layer is in the range of about 0.1 to 5 μm.

7. The hollow toner of claim 1, wherein the hollow sphere structure is filled with air.

8. The hollow toner of claim 1, wherein the polymer is a polymer formed from a polymerizable monomer.

9. The hollow toner of claim 1, wherein the polymer is selected from the group consisting of a homopolymer, a random copolymer, a graft copolymer, and a block copolymer.

10. The hollow toner of claim 8, wherein the polymerizable monomer is at least one monomer selected from the group consisting of a vinyl monomer, a polar monomer having a carboxyl group, a monomer having an unsaturated polyester group, and a monomer having a fatty acid group.

11. The hollow toner of claim 8, wherein the polymerizable monomer is at least one monomer selected from the group consisting of a styrene-based monomer; acrylate or methacrylate; a (meth)acrylate derivative; an ethylenically unsaturated monoolefin; a halogenated vinyl; a vinylester; a vinyl ether; a vinyl ketone; and a nitrogen-containing vinyl compound.

12. The hollow toner of claim 8, wherein the polymerizable monomer is a monomer selected from the group consisting of a styrene, vinyl toluene, α-methylstyrene, methyl acrylate, ethyl acrylate, propyl acrylate, butyl acrylate, 2-ethyl hexyl acrylate, dimethylamino ethyl acrylate, methyl methacrylate, ethyl methacrylate, propyl methacrylate, butyl methacrylate, 2-ethyl hexyl methacrylate, dimethylaminoethyl methacrylate, acrylonitrile, methacrylonitrile, acrylamide, methacryl amide, ethylene, propylene, butylene; vinyl chloride, vinylidene chloride, vinyl fluoride, vinyl acetate, vinyl propionate, vinyl methyl ether, vinyl ethyl ether, vinyl methyl ketone, methyl isoprophenyl ketone, 2-vinylpyridine, 4-vinylpyridine, and N-vinyl pyrrolidone.

13. The hollow toner of claim 1, wherein the pigment is selected from the group consisting of yellow, magenta, cyan and black pigment.

14. The hollow toner of claim 1, wherein the amount of the pigment is in the range of about 0.1 to 20 parts by weight based on 100 parts by weight of the polymer.

15. The hollow toner of claim 1, wherein the wax is at least one wax selected from the group consisting of polyethylene-based wax, polypropylene-based wax, silicon wax, paraffin-based wax, ester-based wax, carnauba wax and metallocene wax.

16. The hollow toner of claim 1, wherein the amount of the wax is in the range of about 0.1 to 10 parts by weight based on 100 parts by weight of the polymer.

17. The hollow toner of claim 1, wherein the surface of the hollow toner further comprises an external additive.

18. A process of preparing a hollow toner, the process comprising:
preparing a dispersion mixture by mixing a polymerizable monomer, a wax, a pigment, a polymerization initiator and a hydrophobic solvent;
preparing a dispersion medium by dissolving a dispersion stabilizer in a water-based solvent;
passing the dispersion mixture through pores of a porous membrane under pressure into the dispersion medium and forming droplets of the dispersion mixture in the dispersion medium;
polymerizing the polymerizable monomer of the droplets of the dispersion mixture in the dispersions medium and forming particles having a polymer outer shell layer; and
drying the particles to form hollow toner particles.

19. The process of claim 18, wherein the polymerization initiator is selected from the group consisting of potassium persulfate, ammonium persulfate, 4,4-azobis(4-cyano valeric acid), dimethyl-2,2′-azobis(2-methyl propionate), 2,2-azobis(2-amidinopropane)dihydrochloride, 2,2-azobis-2-methyl-N-1, 1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile), methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, and di-t-butylperoxy isophthalate.

20. The process of claim 18, wherein a pore size of the membrane is in the range of about 2 to 10 μm.

21. The process of claim 18, wherein a pore size of the membrane is in the range of about 4 to 6 μm.

22. The process of claim 18, wherein the hydrophobic solvent is a hydrocarbon-based solvent.

23. The process of claim 18, further comprising treating the hollow particles obtained in the drying step using external additives.

24. The process of claim 18, wherein the polymerizable monomer is at least one monomer selected from the group consisting of a vinyl monomer, a polar monomer having a carboxyl group, a monomer having an unsaturated polyester group, and a monomer having a fatty acid group.

25. The process of claim 18, wherein the obtained hollow toner has a monodispersed particle size distribution.

26. The process of claim 18, wherein the particles formed in the dispersion medium encapsulate the hydrophobic solvent, and wherein the drying step removes the hydrophobic solvent to form the hollow toner particles with a cavity containing air.

27. A method of forming an image comprising:
attaching a toner to the surface of a photoreceptor on which an electrostatic latent image is formed to form a visualized image; and
transferring the visualized image to a transfer medium, wherein the toner is a hollow toner according to claim 1.

28. An apparatus for forming an image comprising:
an organic photoreceptor;
an image forming unit that forms an electrostatic latent image on the surface of the organic photoreceptor;
an unit for receiving a hollow toner according to claim 1;
a toner supply unit that supplies the hollow toner onto the surface of the organic photoreceptor in order to form a toner image by developing the electrostatic latent image; and
a toner transferring unit that transfers the toner image to a transfer medium from the surface of the organic photoreceptor.
